(19) United States
(12) Patent Application Publication
(10) Pub. No.: US 2023/0054393 A1
(43) Pub. Date: Feb. 23, 2023

(54) INCENTIVE GRANTING SYSTEM AND INCENTIVE GRANTING METHOD

(71) Applicant: TOYOTA JIDOSHA KABUSHIKI KAISHA, Toyota-shi Aichi-ken (JP)

(72) Inventors: Keiji Kaita, Miyoshi-shi Aichi-ken (JP); Masaya Yamamoto, Toyota-shi Aichi-ken (JP); Takahiko Hirasawa, Toyota-shi Aichi-ken (JP)

(73) Assignee: TOYOTA JIDOSHA KABUSHIKI KAISHA, Toyota-shi Aichi-ken (JP)

(21) Appl. No.: 17/851,515

(22) Filed: Jun. 28, 2022

(30) Foreign Application Priority Data
Aug. 19, 2021 (JP) 2021-134305

(51) Int. Cl. G06Q 30/02

(52) U.S. Cl. CPC G06Q 30/0226; G01C 21/3469

(57) ABSTRACT

An incentive granting system grants an incentive to CO₂ reduction traveling by a user of the vehicle that directly or indirectly emits CO₂. The incentive granting system includes one or more processors, and is configured to grant a reward point to the user, in the vehicle traveling from a current location to a destination, based on at least one of selection of a traveling route in which a CO₂ emission amount is reduced with respect to a standard traveling route, selection of a traveling mode, and reduction of an actual CO₂ emission amount with respect to a standard CO₂ emission amount.

### CROSS REFERENCE TO RELATED APPLICATION

This application claims priority to Japanese Patent Application No. 2021-134305 filed on Aug. 19, 2021, incorporated herein by reference in its entirety.

### BACKGROUND

### 1. Technical Field

The present disclosure relates to an incentive granting system and an incentive granting method granting an incentive to CO₂ reduction traveling by a user of a vehicle that directly or indirectly emits CO₂.

### 2. Description of Related Art

Japanese Unexamined Patent Application Publication No. 2011-141272 (JP 2011-141272 A) discloses a navigation device. The navigation device calculates a carbon dioxide emission amount (CO₂ emission amount) emitted by traveling along a guide route from a departure point to a destination, and acquires emission credit trading price information of CO₂. Then, the navigation device calculates the emission credit price of CO₂ emitted by traveling along the guide route based on the CO₂ emission amount and emission credit trading price information, and displays the emission credit price on a display along with the CO₂ emission amount. Further, the navigation device can present to a user a plurality of guide routes with which the CO₂ emission amount and the emission credit price are associated.

### SUMMARY

In JP 2011-141272 A, the user’s awareness of the emission of CO₂ is expected to rise by allowing the user to grasp the CO₂ emission amount emitted by traveling from the departure point to the destination as well as the emission credit price. However, it cannot be said that the measures of notifying the emission credit price in this way alone are sufficient to evoke the active action of the user for CO₂ reduction, and it is considered that there is room for improvement.

This disclosure has been made in view of the above-mentioned problems, and provides an incentive granting system and an incentive granting method that contribute to action evocation of the user for the CO₂ reduction.

An incentive granting system of a first aspect of the present disclosure is configured to grant an incentive to CO₂ reduction traveling by a user of a vehicle that directly or indirectly emits CO₂. The incentive granting system includes one or more processors. The one or more processors are configured to grant a reward point to the user, in the vehicle traveling from a current location to a destination, based on at least one of selection of a traveling route in which a CO₂ emission amount is reduced with respect to a standard traveling route, selection of a traveling mode in which the CO₂ emission amount is reduced with respect to a standard traveling mode, and reduction of an actual CO₂ emission amount with respect to a standard CO₂ emission amount.

In the first aspect of the present disclosure, the one or more processors may grant the reward point more as a reduction amount of the actual CO₂ emission amount with respect to the standard CO₂ emission amount is larger.

In the first aspect of the present disclosure, the one or more processors may grant the reward point more as a CO₂ emission amount associated with the traveling route selected by the user is smaller than a CO₂ emission amount associated with the standard traveling route.

In the first aspect of the present disclosure, the one or more processors may grant the reward point more as a CO₂ emission amount associated with the traveling mode selected by the user is smaller than a CO₂ emission amount associated with the standard traveling mode.

In the first aspect of the present disclosure, the standard CO₂ emission amount may be decided based on an average value of CO₂ emission amounts emitted when a plurality of vehicles of the same model as the vehicle travel according to the traveling route selected by the user.

In the first aspect of the present disclosure, the standard CO₂ emission amount may be decided based on an average value of CO₂ emission amounts emitted when a plurality of vehicles of the same model as the vehicle travel according to the standard traveling route.

An incentive granting method of a second aspect of the present disclosure is configured to grant an incentive to CO₂ reduction traveling by a user of a vehicle that directly or indirectly emits CO₂. The incentive granting method grants a reward point to the user, in the vehicle traveling from a current location to a destination, based on at least one of selection of a traveling route in which a CO₂ emission amount is reduced with respect to a standard traveling route, selection of a traveling mode in which the CO₂ emission amount is reduced with respect to a standard traveling mode, and reduction of an actual CO₂ emission amount with respect to a standard CO₂ emission amount.

According to the incentive granting system of the first aspect and the incentive granting method of the second aspect of the present disclosure, the reward point is granted to the user who has performed the CO₂ reduction traveling that involves at least one act of selection of a traveling route, selection of a traveling mode, and reduction of a CO₂ emission amount during traveling. The user who has performed the CO₂ reduction traveling in this way is granted the reward point as an incentive for the CO₂ reduction traveling, so that the action evocation of the user for the CO₂ reduction can be promoted.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically showing an example of a configuration of an incentive granting system according to an embodiment;

FIG. 2 is a flowchart showing an example of a flow of processing executed in the incentive granting system at the time of a CO₂ reduction challenge according to the embodiment;

FIG. 3 is a diagram showing an example of a traveling route candidate presented to a user by processing of step S102;

FIG. 4 is a table showing an example of a traveling mode candidate selected by a user;

FIG. 5 is a flowchart showing an example of specific processing of granting determination of a reward point in step S208;

FIG. 6 is a graph for illustrating another example of reward point granting based on a CO₂ reduction amount;

FIG. 7 is a graph for illustrating another example of reward point granting based on a selection of a traveling route;

FIG. 8 is a graph for illustrating an example of reward point granting based on a selection of the traveling mode; and

FIG. 9 is a flowchart showing another example of specific processing of reward point calculation.

### DETAILED DESCRIPTION OF EMBODIMENTS

Hereinafter, embodiments of the present disclosure will be described with reference to the accompanying drawings. When a number, such as the number of articles, a quantity, an amount, a range, and the like of each element is referred to in the embodiment shown below, except when the number is explicitly stated or when the number is clearly specified in principle, the technical idea relating to the present disclosure is not limited to the number mentioned above.

### System Configuration

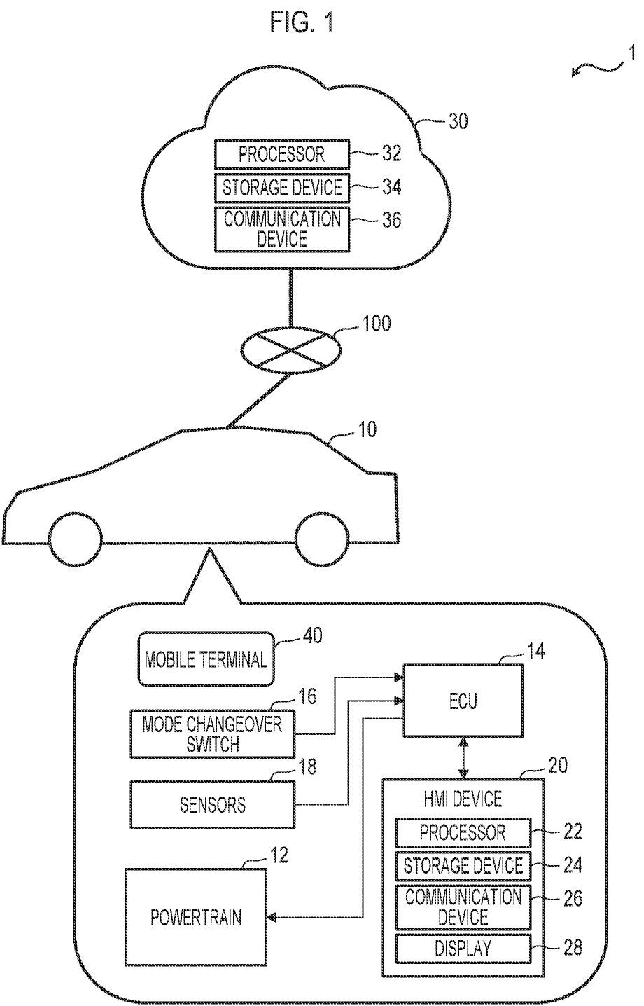

FIG. 1 is a diagram schematically showing an example of a configuration of an incentive granting system 1 according to an embodiment. FIG. 1 shows a vehicle 10 that uses the incentive granting system (hereinafter, also simply referred to as a “system”) 1.

The vehicle 10 is a vehicle that directly or indirectly emits CO₂. More specifically, the vehicle 10 is, for example, a vehicle that emits CO₂ from the vehicle 10 during traveling because an internal combustion engine is included as a power source. Specific examples of such a vehicle include a pure internal combustion engine vehicle (ICEV), a hybrid electric vehicle (HEV), and a plug-in hybrid electric vehicle (PHEV). Further, a battery electric vehicle (BEV) does not directly emit CO₂ during traveling. However, when CO₂ is emitted in the process of generating electric power to be charged in the battery, the traveling of the BEV indirectly emits CO₂. Therefore, BEV is also included in the example of the vehicle 10.

As shown in FIG. 1, the vehicle 10 includes a powertrain 12, an electronic control unit (ECU) 14, a mode changeover switch 16, sensors 18, and a human machine interface (HMI) device 20. The powertrain 12 includes, for example, one or both of an internal combustion engine and an electric motor. The ECU 14 includes a processor and a storage device, and controls the powertrain 12 for vehicle traveling.

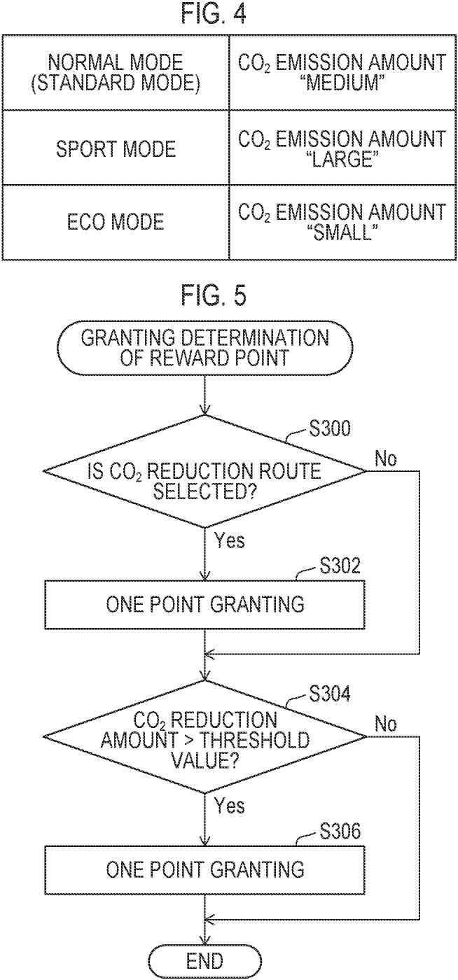

A mode changeover switch 16 is operated by the user (driver) of the vehicle 10 and can change a traveling mode. An example of the traveling mode is a normal mode, a sport mode, and an eco mode, as will be described later with reference to FIG. 4. Sensors 18 include a plurality of sensors to acquire various traveling information, such as an accelerator operation amount, a vehicle speed, and a traveling distance. Further, in the example of the BEV and the PHEV that can travel on the electric power of the battery supplied from the outside, the sensors 18 include a voltage sensor that detects the voltage between the terminals of the battery and a current sensor that detects the current consumption of the battery.

An HMI device 20 is an interface to provide information to the user of the vehicle 10 and receive information from the user. The HMI device 20 includes a processor 22, a storage device 24, a communication device 26, and a display 28. When the processor 22 executes the program stored in the storage device 24, various processing by the HMI device 20 is realized. The mode changeover switch 16 may be integrated into the HMI device 20. The display 28 is, for example, a touch panel kind.

The processor 22 executes processing of acquiring various traveling information using the sensors 18. The storage device 24 stores map information. Further, the HMI device 20 has a built-in global navigation satellite system (GNSS) receiver. The processor 22 executes processing of specifying the current position (current location) of the vehicle 10 on the map based on the map information and the information from the GNSS receiver.

The communication device 26 executes information communication (transmission and reception of information) with a communication device 36 of a cloud server 30, which will be described later, via a wireless communication network 100 such as 4G or 5G. The display 28 displays various information (navigation information, reward point information, and the like) to be transmitted to the user.

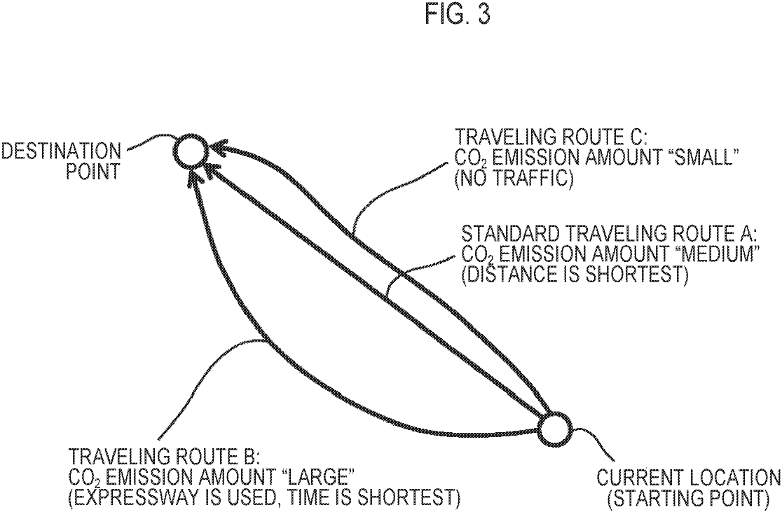

The HMI device 20 has a navigation function. Specifically, the processor 22 executes processing of searching for a traveling route from the current location to the destination set by the user. The processor 22 is configured to search for a plurality of different traveling routes (for example, see FIG. 3 described later) associated with CO₂ emission amount information during traveling according to each traveling route. A plurality of searched traveling routes is displayed on the display 28.

Further, the system 1 includes the cloud server 30 (hereinafter, also simply referred to as “cloud”). The cloud 30 includes a processor 32, a storage device 34, and the communication device 36. When the processor 32 executes the program stored in the storage device 34, various processing by the cloud 30 is realized.

The user of the vehicle 10 possesses a mobile terminal 40. The mobile terminal 40 is, for example, a smartphone or a tablet PC (personal computer), and includes a processor, a storage device, and a communication device. The communication device can execute information communication with the communication device 36 of the cloud 30 via the wireless communication network 100.

### CO₂ Reduction Challenge

To promote the action evocation of the user for CO₂ reduction, the incentive granting system 1 of the present embodiment is configured so that the user can execute the “CO₂ reduction challenge” during the vehicle traveling. The CO₂ reduction challenge is an attempt to encourage the user to actively execute CO₂ reduction traveling by granting a reward point as an incentive to CO₂ reduction to the user who travels with a low CO₂ emission amount (CO₂ reduction traveling).

The management of the reward point for each user is executed by the cloud 30. The reward point has a monetary value that can be used for payment of shopping and the like. Specifically, the reward point can be used in various situations, such as a payment of a fuel cost or a charging cost of the vehicle 10 by the user, and payment of shopping in the shopping street or Internet shopping. Further, the reward point may be constructed so that the reward point can be redeemed for cash or converted into electronic money, mileages, or various other points. As a result, the versatility and convenience of the reward point can be further enhanced. For example, a user who has downloaded a dedicated application for the CO₂ reduction challenge can perform such cashing or conversion by operating the mobile terminal 40 and issuing a request to the cloud 30. The issuer of the reward point is, for example, a government, a local government, or an automobile manufacturer.

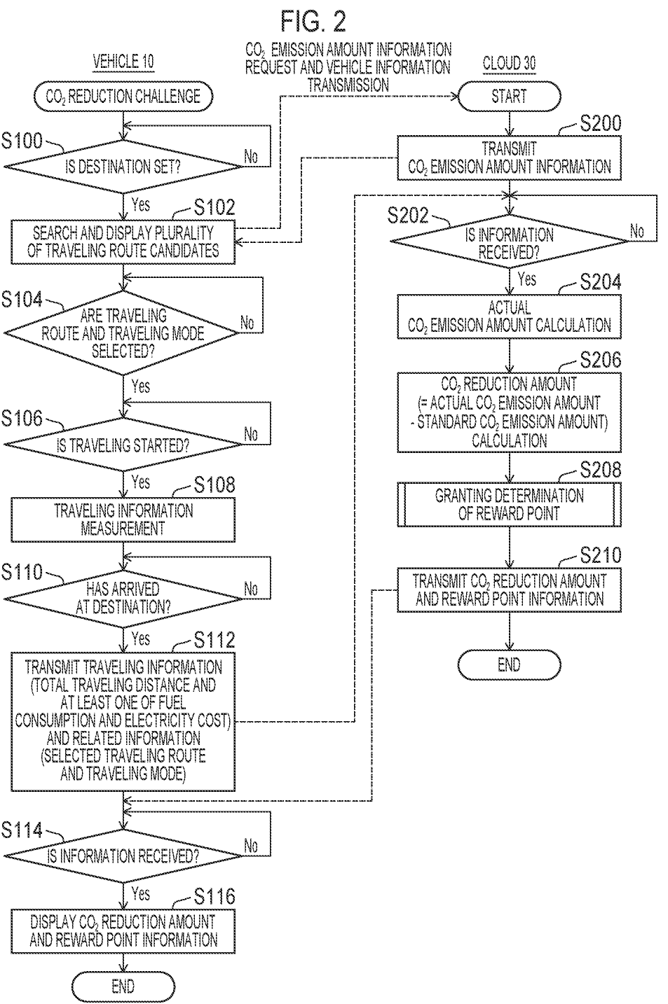

FIG. 2 is a flowchart showing an example of a flow of processing executed in the incentive granting system 1 at the time of a CO₂ reduction challenge according to the embodiment. The processing of the flowchart is executed by the processor 22 on the vehicle side and the processor 32 on the cloud side. However, when the user possesses the mobile terminal 40, at least a portion of the processing by the processor 22 on the vehicle side may be executed by the processor of the mobile terminal 40 operated by the user.

A user who participates in the CO₂ reduction challenge first operates the HMI device 20 (for example, the display 28 of a touch panel kind) to launch a navigation screen and set a destination.

In step S100, the processor 22 on the vehicle side determines whether the destination has been set. After the destination is set, the processor 22 searches for a predetermined number (for example, three) of traveling route candidates in step S102.

After the search for the traveling route candidates is completed, the processor 22 requests the cloud 30 to transmit CO₂ emission amount information obtained by traveling according to each traveling route. The transmission of the request also includes the transmission of vehicle information, such as the model of the vehicle 10 participating in the CO₂ reduction challenge this time.

The processor 32 on the cloud side that receives the above request from the vehicle 10 transmits the CO₂ emission amount information (more specifically, a “standard CO₂ emission amount” described later) of each traveling route candidate to the vehicle 10 in step S200. The processor 22 that receives the CO₂ emission amount information displays each traveling route candidate associated with the standard CO₂ emission amount, on the display 28.

The standard CO₂ emission amount of each of a plurality of traveling routes can be specified by using, for example, so-called big data. Specifically, the storage device 34 of the cloud 30 stores the data of the actual CO₂ emission amount when the vehicle of the same model as the vehicle 10 for which the CO₂ reduction challenge this time is performed has traveled on the same traveling route in the past, in a predetermined number (for example, for 100 vehicles). The processor 32 calculates an average value of the predetermined number of CO₂ emission amounts, and calculates a standard CO₂ emission amount of the traveling route based on the calculated average value. The storage device 34 stores such standard CO₂ emission amount for each model of the vehicles and for each traveling route. More specifically, the standard CO₂ emission amount may be the same as the average value, or may be set higher or lower than the average value based on a predetermined determination index.

Here, a calculation method of an actual CO₂ emission amount (more specifically, a total CO₂ emission amount Xt during traveling on a certain traveling route) used for calculating the standard CO₂ emission amount will be described. In the case of the ICEV and the HEV, a CO₂ emission amount Xeng according to the operation of the internal combustion engine is an example of the total CO₂ emission amount Xt. In the case of the BEV, a CO₂ emission amount Xbat according to the amount of battery electric power consumed during traveling is an example of the total CO₂ emission amount Xt. In the case of the PHEV, the sum of the CO₂ emission amount Xbat in an EV mode of a state in which the internal combustion engine is stopped, and the CO₂ emission amount Xeng in a hybrid mode (HEV mode) in which the internal combustion engine and the electric motor are used for traveling is an example of the total CO₂ emission amount Xt.

The CO₂ emission amount Xeng can be calculated, for example, according to the following equation (1). D is a total traveling distance (km) of the vehicle during traveling on a certain traveling route, and can be calculated based on, for example, the output of a wheel speed sensor. Fe is a fuel consumption (km/l) and can be calculated, for example, by dividing a total traveling distance D by the total fuel consumption amount. The total fuel consumption amount is the amount of fuel consumed in the internal combustion engine during traveling for the total traveling distance D, and can be calculated from the integrated value of the fuel injection amount of the injector measured in the fuel injection device. Kf is a CO₂ emission coefficient (kg-CO₂/1) of fuel per unit fuel amount, and is a value specified according to the kind of fuel, such as gasoline. In addition, the CO₂ emission coefficient Kf is the product of a unit calorific value (MJ/l) and the CO₂ emission coefficient (kg-CO₂/MJ) per unit calorific value.

$$\text{Xeng=D÷Fe×Kf} ... ( 1 )$$

Therefore, the processor 32 of the cloud 30 can acquire the CO₂ emission amount Xeng, which is the basis for calculating the standard CO₂ emission amount, by using the equation (1) by acquiring the data of the total traveling distance D and the fuel consumption Fe from the vehicle that has traveled on a certain traveling route.

The CO₂ emission amount Xbat can be calculated, for example, according to the following equation (2). Ee is an electricity cost (km/kWh), and can be calculated, for example, by dividing the total traveling distance D by the total electric power consumption. The total electric power consumption referred to here can be calculated, for example, by multiplying the voltage between the terminals of the battery, the current consumption, and the time, with respect to the total traveling distance D. Ke is a CO₂ emission coefficient (kg-CO₂/kWh) of electric power per unit electric energy (more specifically, regarding power generation), and varies depending on the country or region. This is because the power source composition differs depending on the country or region.

$$\text{Xbat} \text{=} \text{D} \div \text{Ee} \times \text{Ke}$$

Therefore, the processor 32 can acquire the CO₂ emission amount Xbat, which is the basis for calculation of the standard CO₂ emission amount, by using the equation (2) by acquiring the data of the traveling distance D and an electricity cost Ee from the vehicle that has traveled on a certain traveling route.

In addition, to more accurately calculate the CO₂ reduction amount (= standard CO₂ emission amount - actual CO₂ emission amount), it is desirable that the data of the CO₂ emission amounts Xeng and Xbat, which is the basis for the standard CO₂ emission amount, is acquired not only for the same vehicle model but also for the same model year. Further, in the example of a vehicle, such as the vehicle 10 in which the traveling mode can be selected, it is desirable that the data of the CO₂ emission amounts Xeng and Xbat is acquired for each traveling mode, such as the normal mode. Further, the congestion status of each traveling route (presence or absence of congestion and degree of congestion) differs depending on the time zone. Therefore, it is desirable that the data of the CO₂ emission amounts Xeng and Xbat is acquired for each time zone.

Further, in the above-mentioned example relating to the acquisition of the CO₂ emission amounts Xeng and Xbat, big data of the fuel consumption Fe and the electricity cost Ee is used. However, acquiring such big data depending on, for example, a traveling route may be difficult. In such a case, a predetermined mode traveling value (so-called catalog value) published by each car manufacturer may be simply used as the fuel consumption Fe and the electricity cost Ee to calculate the CO₂ emission amounts Xeng and Xbat.

In the above example, the calculation of the CO₂ emission amounts Xeng and Xbat is executed by the processor 32 of the cloud 30 that acquires the traveling information (the traveling route, the total traveling distance D, the fuel consumption Fe, electricity cost Ee, and the like) from each vehicle. Instead of such an example, the calculation of the CO₂ emission amounts Xeng and Xbat may be performed on the vehicle side. Then, the cloud 30 may store the CO₂ emission amount information (the traveling route, the CO₂ emission amounts Xeng and Xbat, and the like) received from each vehicle in the storage device 34, and may use the CO₂ emission amount information as the basis for calculation of the standard CO₂ emission amount.

FIG. 3 is a diagram showing an example of a traveling route candidate presented to a user by processing of step S102. In the above example, traveling routes A to C, which are three traveling route candidates, are presented. The current location (that is, the starting point of the CO₂ reduction challenge) is, for example, the departure point after the user gets on board, but is not necessarily limited to the departure point, and may be an optional point during the vehicle traveling. The standard CO₂ emission amount displayed in association with each traveling route A to C is a value in the same traveling mode (for example, the standard traveling mode).

The traveling route A is a route that has the shortest distance from the current location to the destination and does not use the expressway. The CO₂ emission amount from traveling along the traveling route A is “medium” (an intermediate portion of the routes A to C). The traveling route A is presented as a “standard traveling route”.

The traveling route B is a route that uses an expressway. The traveling route B has the longest distance to the destination but the shortest needed time. The CO₂ emission amount of the traveling route B is “large” (the highest among the routes A to C).

The traveling route C is a route that does not use the expressway like the traveling route A. The traveling route C is longer than the traveling route A, but is a vacant route as compared with the traveling route A. Therefore, the CO₂ emission amount of the traveling route C is “small” (the lowest among the routes A to C).

In step S104 following step S102, the processor 22 on the vehicle side determines whether the traveling route and traveling mode have been selected by the user. In the example shown in FIG. 3, the user selects a desired traveling route from the traveling routes A to C including the standard traveling route A. Further, in the example of a vehicle, such as the vehicle 10 in which a traveling mode can be selected, the user selects a desired traveling mode when the user participates in the CO₂ reduction challenge.

FIG. 4 is a table showing an example of a traveling mode candidate selected by a user. When the vehicle 10 accepts the user’s selection of a traveling mode, for example, the information shown in FIG. 4 is displayed on the display 28. In FIG. 4, three traveling modes selectable by using the mode changeover switch 16, that is, a normal mode, a sport mode, and an eco mode, are shown together with CO₂ emission amount information associated with each traveling mode.

The normal mode is set as a standard traveling mode with a good balance between at least one of the fuel consumption Fe and the electricity cost Ee, and traveling performance, and is an example of a “standard traveling mode”. The sport mode (or power mode) is a mode in which the responsiveness of the vehicle driving force to the depression of the accelerator pedal is enhanced as compared with the normal mode, and high traveling performance is exhibited. The eco mode is a mode in which the responsiveness of the vehicle driving force to the depression of the accelerator pedal is suppressed to be lower as compared with the normal mode, and the performance of at least one of the fuel consumption Fe and the electricity cost Ee is enhanced.

Therefore, as the level of the CO₂ emission amount, the normal mode is “medium”, the sport mode is “large”, and the eco mode is “small”. As described above, the CO₂ emission amount information displayed on the display 28 for the user to select the traveling mode is, for example, the difference in the relative level of the CO₂ emission amount between the respective traveling modes. However, for example, by using big data of the CO₂ emission amount, for each presented traveling route (for example, the traveling routes A to C), the specific numerical value of the standard CO₂ emission amount at the time of selecting each traveling mode may be displayed.

In addition, in the example in which the vehicle 10 is the PHEV, the traveling mode to be selected in the CO₂ reduction challenge may include, for example, the following control modes A to C. That is, the control modes A to C are modes to provide a plurality of options for the pattern of switching between the EV mode and the HEV mode executed by the ECU 14.

The control mode A is a standard mode of the PHEV in which the EV mode is selected first at the start of traveling and then switched to the HEV mode after the battery electric power is consumed. Therefore, the control mode A is an example of the standard traveling mode in the control modes A to C. The control mode B is a mode that is needed when, for example, an urban area is the destination. The control mode B is a mode in which the battery electric power is preserved by accelerating the switching time from the EV mode used at the start of traveling to the HEV mode as compared with the control mode A, to perform the EV mode during traveling in an urban area near the destination. The control mode C is a mode in which the EV mode and the HEV mode are appropriately (when needed, frequently) switched to maximize the fuel consumption Fe and the electricity cost Ee in consideration of the set traveling route. Specifically, in the control mode C, the HEV mode is selected, for example, when the vehicle traveling load is high, such as at the time of a high vehicle speed, and the EV mode is selected, for example, when the vehicle traveling load is low, such as at the time of a low vehicle speed. The levels of the CO₂ emission amount of such control modes A, B, and C are “medium”, “large”, and “small”, respectively.

After the traveling route and the traveling mode are selected by the user in step S104, the processing proceeds to step S106. In step S106, the processor 22 determines whether the vehicle 10 has started traveling.

As a result, when the traveling of the vehicle 10 is started, the processor 22 executes measurement of the traveling information relevant for calculating the actual CO₂ emission amount of the vehicle 10 in the CO₂ reduction challenge this time in step S108. The travel information referred to here includes the traveling distance and the integrated fuel injection amount after the start of traveling when the operation of the internal combustion engine is involved. Further, when the electric power consumption of the battery is involved, the traveling information includes the traveling distance and the integrated electric power consumption after the start of traveling. The measurement is performed until the vehicle 10 arrives at the destination.

In step S110, the processor 22 determines whether the vehicle 10 has arrived at the destination. As a result, when the vehicle 10 arrives at the destination, the processor 22 transmits the final traveling information (that is, the total traveling distance D and at least one of the fuel consumption Fe and the electricity cost Ee) obtained by the measurement during traveling in step S112, to the cloud 30. Further, the processor 22 transmits related information (that is, information on the traveling route and the traveling mode selected by the user in the CO₂ reduction challenge this time) to the cloud 30.

When the processor 32 on the cloud side receives the traveling information and the related information from the vehicle 10 in step S202, the processor 32 calculates the actual CO₂ emission amount of the vehicle 10 in the CO₂ reduction challenge this time based on the received traveling information and the related information in step S204. The calculation of actual CO₂ emission amount can be performed by using at least one of the equations (1) and (2).

Next, in step S206, the processor 32 calculates the CO₂ reduction amount. The CO₂ reduction amount is calculated by subtracting the standard CO₂ emission amount from the actual CO₂ emission amount. The standard CO₂ emission amount used in the calculation is a value associated with the traveling route selected by the user for the CO₂ reduction challenge this time. Further, it is desirable that the standard CO₂ emission amount is a value associated with the traveling mode selected by the user this time.

Next, in step S208, the processor 32 executes the granting determination of the reward point. Specifically, FIG. 5 is a flowchart showing an example of specific processing of granting determination of the reward point in step S208. The management of the reward point is executed in the cloud 30 as described above. Therefore, the storage device 34 stores the personal information (for example, the name) of the user who performs the CO₂ reduction challenge.

In FIG. 5, in step S300, the processor 32 determines whether the CO₂ reduction route is selected in the CO₂ reduction challenge this time. Specifically, the processor 32 determines whether the traveling route selected this time is a traveling route with less CO₂ emission amount than the standard traveling route.

As a result, when the CO₂ reduction route is selected (in the example shown in FIG. 3, when the traveling route C is selected), the processor 32 executes processing of increasing the number of possessed points of the user by one point in step S302. After that, the processing proceeds to step S304. The number of points to be added may be two or more.

On the other hand, when the CO₂ reduction route is not selected in step S300 (in the example shown in FIG. 3, when the traveling route A or B is selected), the addition of the reward point is not performed, and the processing directly proceeds to step S304.

In step S304, the processor 32 determines whether the CO₂ reduction amount (see step S206) is larger than a predetermined threshold value TH. As a result, when the determination result is affirmative, the processor 32 executes processing of increasing the number of possessed points of the user by one point in step S306. The number of points to be added may be two or more.

On the other hand, when the CO₂ reduction amount is equal to or less than the threshold value TH in step S304, the addition of the reward point is not performed.

In addition, in step S304, the processor 32 may compare the CO₂ reduction amount by the CO₂ reduction challenge this time (in other words, one time) with the threshold value TH, as in the above example. Instead of such an example, the integrated value of the CO₂ reduction amounts obtained by a plurality of CO₂ reduction challenges may be compared with the threshold value TH. More specifically, when the CO₂ reduction amount is equal to or less than the threshold value TH in step S304, the processor 32 may store the CO₂ reduction amount in the storage device 34. The CO₂ reduction amount stored in the storage device 34 in this way may be integrated each time the CO₂ reduction amount is determined to be equal to or less than the threshold value TH in each CO₂ reduction challenge. Then, when the integrated value of the CO₂ reduction amount is larger than the threshold value TH in the subsequent CO₂ reduction challenge, the number of possessed points may be increased by a predetermined point (for example, one point), and the above-mentioned integrated value may be reset to zero.

In FIG. 2, in step S210 following step S208, the processor 32 transmits the CO₂ reduction amount in the CO₂ reduction challenge this time and the reward point information to the vehicle 10. The reward point information includes, for example, the number of reward points acquired this time and the number of possessed points reflecting whether the reward points have been acquired this time. Further, the information transmitted to the vehicle 10 may include the cumulative CO₂ reduction amount due to the CO₂ reduction traveling of the user.

In step S114, the processor 22 that has received the CO₂ reduction amount and the reward point information from the cloud 30 displays the CO₂ reduction amount and the reward point information on the display 28 (step S 116). Further, for example, the cumulative CO₂ reduction amount described above may also be displayed on the display 28.

The processing shown in FIG. 2 may be modified as follows. That is, the calculation of the actual CO₂ emission amount (step S204) may be executed by the processor 22 on the vehicle side, and the calculated actual CO₂ emission amount may be transmitted to the cloud 30. Alternatively, the processor 22 on the vehicle side may receive the standard CO₂ emission amount from the cloud 30, and may calculate not only the actual CO₂ emission amount but also the CO₂ reduction amount. Then, the processor 22 may display the calculated CO₂ reduction amount on the display 28 and transmit the calculated CO₂ reduction amount to the cloud 30. Further, the CO₂ reduction amount and the reward point information may be transmitted to the mobile terminal 40 of the user directly from the cloud 30 or from the cloud 30 via the vehicle 10 and may be displayed on the mobile terminal 40.

In addition, in the processing shown in FIG. 2, when the traveling mode is changed by the user during the vehicle traveling toward the destination, the CO₂ reduction challenge this time may be canceled and invalidated. Alternatively, the calculation of the CO₂ reduction amount and the evaluation for the presence or absence of granting of the reward point may be performed based on the traveling result up to the point at which the traveling mode is changed.

### Effect

The incentive granting system 1 of a first aspect of the disclosure described above allows, in the vehicle traveling from the current location to the destination, the reward point can be granted to the user who has performed the CO₂ reduction traveling by selecting the traveling route (the CO₂ reduction route) in which the CO₂ emission amount is reduced with respect to the standard traveling route. Further, the reward point is granted to the user who has performed traveling with the CO₂ reduction amount exceeding the threshold value. The system 1 allows the user who has performed the CO₂ reduction traveling in this way is granted the reward point as an incentive for the CO₂ reduction traveling, so that the action evocation of the user for the CO₂ reduction can be promoted.

In addition, the incentive granting system 1 of the first aspect of the disclosure allows, for example, by informing the user of the cumulative CO₂ reduction amount, the user can grasp how much the user’s traveling has been able to contribute to the environment so far. As a result, the CO₂ reduction awareness of the user regarding the selection of a traveling route and a traveling method (including the selection of the traveling mode) can be fostered. Then, the user can enjoy the financial merit by converting the degree of contribution to CO₂ reduction into points. Further, the cumulative CO₂ reduction amount by all the users who have participated in the CO₂ reduction challenge may also be displayed on the display 28. As a result, the significance of the CO₂ reduction challenge provided by the system 1 can be further permeated to the user, a passenger, and the people in the vicinity who see the result.

### Another Example of Reward Point Granting

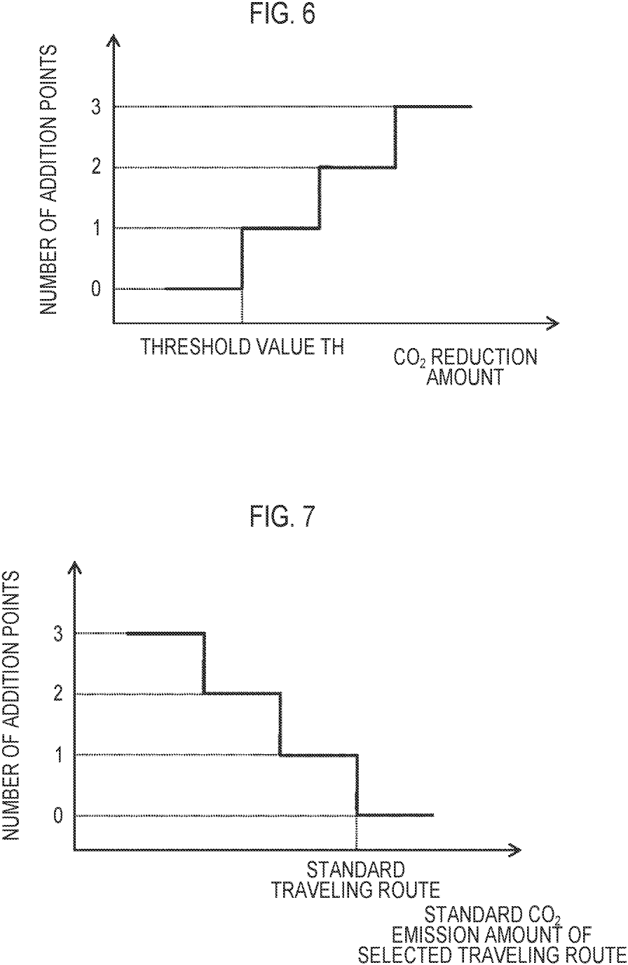

FIG. 6 is a diagram for illustrating another example of reward point granting based on a CO₂ reduction amount. In the example shown in FIG. 5 above, when the CO₂ reduction amount is larger than the threshold value TH, a uniform reward point (for example, one point) is added. On the other hand, the processor 32 may grant more reward points as the CO₂reduction amount is larger. As a result, the action evocation of the user for the CO₂ reduction, as compared with the example of granting a uniform reward point can be further promoted. Specifically, in the example shown in FIG. 6, when the CO₂ reduction amount is larger than the threshold value TH, the number of addition points increases as the CO₂ reduction amount increases.

FIG. 7 is a diagram for illustrating another example of reward point granting based on a selection of a traveling route. In the example shown in FIG. 5 above, a uniform reward point is added when a traveling route (CO₂ reduction route) having a smaller CO₂ emission amount than the standard traveling route is selected. On the other hand, the processor 32 may grant more reward points as the CO₂ emission amount associated with the traveling route selected by the user is smaller than the CO₂ emission amount associated with the standard traveling route. As a result, the action evocation of the user for the CO₂ reduction, as compared with the example of granting a uniform reward point can be further promoted.

Specifically, the horizontal axis in FIG. 7 is the standard CO₂ emission amount of the traveling route selected by the user. The standard CO₂ emission amount can be acquired by the method described above (for example, a method using big data). In the example shown in FIG. 7, when the standard CO₂ emission amount of the selected traveling route is less than the standard CO₂ emission amount of the standard traveling route, the number of addition points increases as the standard CO₂ emission amount decreases.

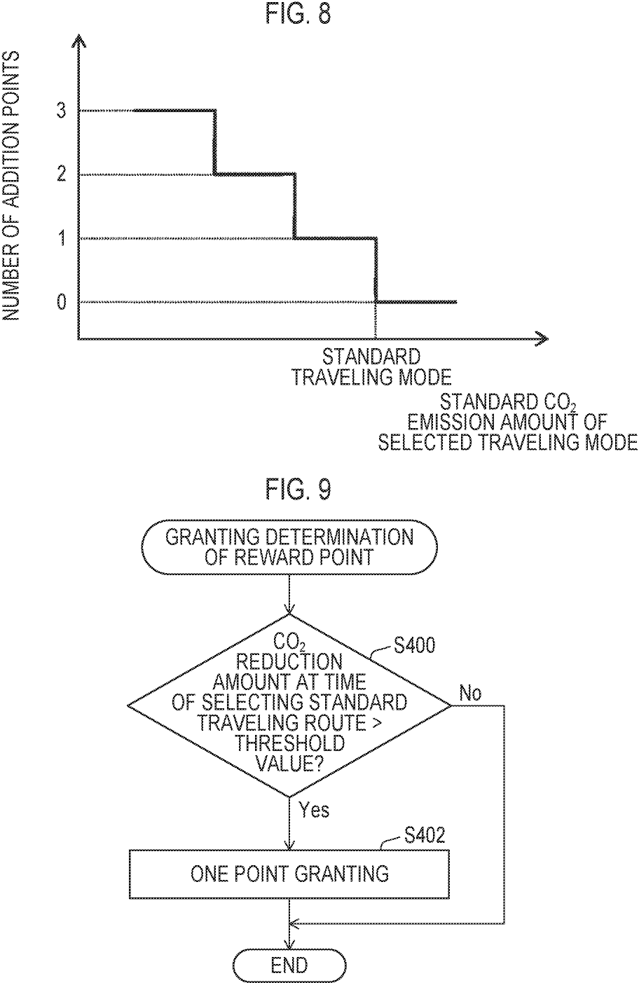

FIG. 8 is a diagram for illustrating an example of reward point granting based on a selection of the traveling mode. Further, in the above-mentioned example shown in FIG. 5, the granting of the reward point is not performed based on the selection of the traveling mode by the user itself. Instead of such an example, the granting of the reward point may be given based on the selection result of the traveling mode. For example, by the same processing as the processing of steps S300 and S302 shown in FIG. 5, a uniform reward point may be added when a traveling mode (CO₂ reduction mode) having a smaller CO₂ emission amount than the standard traveling mode is selected. In the example shown in FIG. 4, the reward point may be added when the eco mode is selected.

Further, the processor 32 may grant more reward points as the CO₂ emission amount associated with the traveling mode selected by the user is smaller than the CO₂ emission amount associated with the standard traveling mode. As a result, the action evocation of the user for the CO₂ reduction, as compared with the example of granting a uniform reward point can be further promoted. In the example shown in FIG. 8, when the standard CO₂ emission amount of the selected traveling mode is less than the standard CO₂ emission amount of the standard traveling mode, the number of addition points increases as the standard CO₂ emission amount decreases.

FIG. 9 is a flowchart showing another example of specific processing of reward point calculation. In the example shown in FIG. 5 above, the granting of the reward point based on the selection of the CO₂ reduction route and the granting of the reward point based on the CO₂ reduction amount are separately performed. Further, in the example shown in FIG. 5, the standard CO₂ emission amount, which is the basis for calculating the CO₂ reduction amount, is decided based on the average value of the CO₂ emission amounts emitted when a plurality of vehicles of the same model as the vehicle 10 travel according to the “traveling route selected by the user”.

On the other hand, the standard CO₂ emission amount, which is the basis for calculating the CO₂ reduction amount in the example shown in FIG. 9, is decided as follows. That is, the standard CO₂ emission amount is decided based on the average value of the CO₂ emission amounts emitted when the vehicles of the same model as the vehicle 10 travel according to the “standard traveling route”. In the example of the vehicle, such as the vehicle 10 in which the traveling mode can be selected, the average value may be calculated based on, for example, the data of the CO₂ emission amount at the time of selecting the standard traveling mode.

In the example shown in FIG. 9 in which the standard CO₂ emission amount decided as described above is used, in step S400, the processor 32 determines whether the CO₂ reduction amount in which the comparison target is at the time of selecting the standard traveling route is more than a threshold value. When the determination result is affirmative, the processing of step S402 (similar to the processing of step S306) is executed, and the reward point is added.

The granting of the reward point may be performed as in the example shown in FIG. 9 described above. According to such an example, the presence or absence of the granting of the reward point is determined based on the CO₂ reduction amount when the selection of the traveling route and the traveling method of the user are comprehensively evaluated.

In addition, the granting of the reward point of the user in “the incentive granting system and the incentive granting method” according to the present disclosure, may be executed, in a mode other than the above-mentioned examples, based on at least one of “the selection of a traveling route in which the CO₂ emission amount is reduced with respect to the standard traveling route”, “the selection of a traveling mode in which the CO₂ emission amount is reduced with respect to the standard traveling mode”, and “the reduction of the actual CO₂ emission amount with respect to the standard CO₂ emission amount”.

What is claimed is:

1. An incentive granting system granting an incentive to CO₂ reduction traveling by a user of a vehicle that directly or indirectly emits CO₂, the incentive granting system comprising one or more processors,
wherein the one or more processors are configured to grant a reward point to the user, in the vehicle traveling from a current location to a destination, based on at least one of selection of a traveling route in which a CO₂ emission amount is reduced with respect to a standard traveling route, selection of a traveling mode in which the CO₂ emission amount is reduced with respect to a standard traveling mode, and reduction of an actual CO₂ emission amount with respect to a standard CO₂ emission amount.

2. The incentive granting system according to claim 1, wherein the one or more processors grant the reward point more as a reduction amount of the actual CO₂ emission amount with respect to the standard CO₂ emission amount is larger.

3. The incentive granting system according to claim 1, wherein the one or more processors grant the reward point more as a CO₂ emission amount associated with the traveling route selected by the user is smaller than a CO₂ emission amount associated with the standard traveling route.

4. The incentive granting system according to claim 1, wherein the one or more processors grant the reward point more as a CO₂ emission amount associated with the traveling mode selected by the user is smaller than a CO₂ emission amount associated with the standard traveling mode.

5. The incentive granting system according to claim 1, wherein the standard CO₂ emission amount is decided based on an average value of CO₂ emission amounts emitted when a plurality of vehicles of the same model as the vehicle travel according to the traveling route selected by the user.

6. The incentive granting system according to claim 1, wherein the standard CO₂ emission amount is decided based on an average value of CO₂ emission amounts emitted when a plurality of vehicles of the same model as the vehicle travel according to the standard traveling route.

7. An incentive granting method granting an incentive to CO₂ reduction traveling by a user of a vehicle that directly or indirectly emits CO₂, the incentive granting method comprising granting a reward point to the user, in the vehicle traveling from a current location to a destination, based on at least one of selection of a traveling route in which a CO₂ emission amount is reduced with respect to a standard traveling route, selection of a traveling mode in which the CO₂ emission amount is reduced with respect to a standard traveling mode, and reduction of an actual CO₂ emission amount with respect to a standard CO₂ emission amount.
